(19) United States
(12) Patent Application Publication
(10) Pub. No.: US 2023/0390037 A1
(43) Pub. Date: Dec. 7, 2023

(54) DENTAL FLOSS HOLDER

(71) Applicant: ZHENG Lei, WENZHOU (CN)

(72) Inventor: ZHENG Lei, WENZHOU (CN)

(21) Appl. No.: 18/327,951

(22) Filed: Jun. 2, 2023

Related U.S. Application Data
(60) Provisional application No. 63/348,886, filed on Jun. 3, 2022.

(51) Int. Cl. A61C 15/04

(52) U.S. Cl. CPC A61C 15/046

(57) ABSTRACT

A dental floss holder comprises a handle and two prongs, and a winding column is arranged at the connection point of the handle and the two prongs. A groove is arranged on the outside of two prongs. A winding groove is arranged on the winding column. The winding groove on the winding column is communicated with the groove on the two prongs. The two prongs extend from the upper end of the handle in a direction different from the direction of the central axis of the handle. The winding column comprises a column bottom close to the handle and a column cap away from the handle. The diameter of the column cap is greater than the diameter of the column bottom. The handle of the dental floss holder is perpendicular to the two prongs.

### BACKGROUND

### Field of the Invention

The invention generally relates to a dental cleaning device. More specifically, the invention relates to a dental floss holder.

### Description of the Related Art

With the increasing attention to oral health, people often use dental floss to clean the food residue in the tooth space. If you directly use your hands to wrap the floss to clean the teeth, the operation will be very cumbersome and inconvenient. The existing disposable dental floss picks are usually pre-bound with dental floss and can only be discarded after use, which wastes resources. Another problem with the dental floss picks is that the handle is too short to handle and is not easy to clean the back teeth. The existing dental floss holders with replaceable dental floss function usually have grooves on their U-shaped prongs, and the dental floss is wound around the grooves and fixed, so the dental floss is easy to loosen and affect the use.

### SUMMARY

It is an aspect of the present disclosure to provide a dental floss holder, the dental floss holder comprises a handle and two prongs, and a winding column is arranged at the connection point of the handle and the two prongs. A groove is arranged on the outside of two prongs. A winding groove is arranged on the winding column. The winding groove on the winding column is communicated with the groove on the two prongs. The two prongs extend from the upper end of the handle in a direction different from the direction of the central axis of the handle. The winding column comprises a column bottom close to the handle and a column cap away from the handle. The diameter of the column cap is greater than the diameter of the column bottom. The handle of the dental floss holder is perpendicular to the two prongs.

It is an aspect of the present disclosure to provide a winding groove on the winding column. When winding the dental floss, the user can wind the dental floss to form an 8-shaped shape along the winding groove on the winding column, to make the dental floss more tightly wound.

It is an aspect of the present disclosure to provide a groove on the two prongs connected with the winding groove on the winding column, and the winding groove on the winding column and the groove outside the two prongs are on the same horizontal plane so that the user can wind the dental floss faster.

### BRIEF DESCRIPTION OF THE DRAWINGS

FIG. 1 is a structural diagram of the present invention.

FIG. 2 is a partially enlarged view of the present invention.

### DETAILED DESCRIPTION

All illustrations of the drawings are to describe selected versions of the present invention and are not intended to limit the scope of the present invention. The present invention is to be described in detail and is provided in a manner that establishes a thorough understanding of the present invention. There may be aspects of the present invention that may be practiced or utilized without the implementation of some features as they are described. It should be understood that some details have not been described in detail to the not unnecessarily obscure focus of the invention. References herein to “the preferred embodiment”, “one embodiment”, “some embodiments”, or “alternative embodiments” should be considered to be illustrating aspects of the present invention that may potentially vary in some instances, and should not be considered to be limiting to the scope of the present invention as a whole.

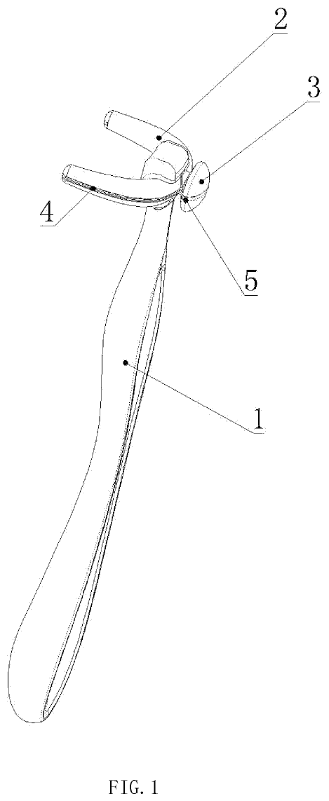

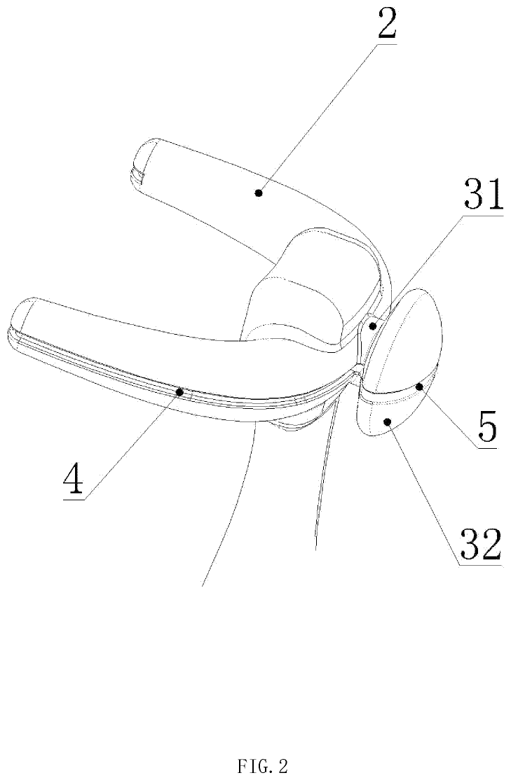

As shown in FIGS. 1-2, the dental floss holder comprises a handle 1 and two prongs 2 connected with the handle 1. The two prongs 2 extend from the upper end of the handle 1 in a direction that is different from the direction of the central axis of the handle 1. The shape of the two prongs 2 can be U-shaped, V-shaped, or other shapes conducive to winding.

As shown in FIGS. 1-2, a winding column 3 is arranged at the connection between the handle 1 and the two prongs 2. The winding column 3 comprises a column bottom 31 close to the handle 1 and a column cap 32 away from the handle 1, and the diameter of the column cap 32 is larger than the diameter of the column bottom 31. The shape of the column cap 32 can be disc-shaped, triangular disc-shaped, hexagonal disc-shaped, or other shapes conducive to winding.

As shown in FIGS. 1-2, in the preferred embodiment, the handle 1 of the dental floss holder is perpendicular to the two prongs 2. The angle between the two prongs 2 and the handle 1 can be 90 degrees or 130 degrees, or other easy-to-use angles.

As shown in FIGS. 1-2, a winding groove 5 on the winding column 3 is connected with the grooves 4 on the outside of the two prongs 2.

As shown in FIGS. 1-2, in the preferred embodiment, the winding groove 5 on the winding column 3 and the groove 4 outside the two prongs 2 are on the same horizontal plane. The angle between the winding groove 5 on the winding column 3 and the groove 4 outside the two prongs 2 can be 90 degrees or 130 degrees, or other easy-to-use angles.

As shown in FIGS. 1-2, when installing dental floss, first wind the dental floss along the winding column 3 for 2-3 circles, then wind the dental floss along the groove 4 to the ends of the two prongs 2, and keep the dental floss tight during the winding process, then wind the dental floss alternately along the column bottom 31 of the winding column 3 and the winding groove 5 to form a circular or a semi-circular shape. Finally, wind the dental floss on the winding column 3 into a shape similar to FIG. 8 to make the dental floss more tightly wound. After use, the dental floss can be replaced in the above way to avoid wasting resources.

The floss holder is made out of any suitable material such as, but not limited to: polymer, stainless steel, aluminum, or any other suitable material.

The embodiment shall not be regarded as a restriction on the present invention, and any noncreative improvement or touch-up based on the present invention shall be regarded as the protection scope of the present invention.

1. A dental floss holder comprising:
a handle;
two prongs extend from the said handle, the said two prongs are capable of holding the dental floss material therebetween;
a winding column is arranged at the connection between the said handle and the said two prongs;
a groove is arranged outside the said two prongs;
a winding groove is arranged on the said winding column.

2. A dental floss holder as defined in claim 1, wherein the said winding groove on the said winding column is connected with the said groove on the said two prongs.

3. A dental floss holder as defined in claim 1, wherein the said winding groove on the said winding column and the said groove outside the said two prongs are on the same horizontal plane.

4. A dental floss holder as defined in claim 1, wherein the said two prongs extend from the upper end of the said handle in a direction different from the direction of the central axis of the said handle.

5. A dental floss holder as defined in claim 1, wherein the said winding column comprises a column bottom close to the said handle and a column cap far away from the said handle, and the diameter of the column cap is greater than the diameter of the column bottom.

6. A dental floss holder as defined in claim 1, wherein the said handle is perpendicular to the said two prongs.
